(19) United States
(12) Patent Application Publication
(10) Pub. No.: US 2020/0230654 A1
(43) Pub. Date: Jul. 23, 2020

(54) SEED SORTING AND SEPARATING SYSTEMS

(71) Applicant: Easy Seed LLC, Buckley, WA (US)

(72) Inventor: Michael Menigoz, Buckley, WA (US)

(21) Appl. No.: 16/252,399

(22) Filed: Jan. 18, 2019

(51) Int. Cl. B07B 4/02; B07B 11/06; B07B 11/08

(52) U.S. Cl. CPC B07B 4/02; B07B 11/08; B07B 11/06

(57) ABSTRACT

A device for separating seeds from other plant material may include a front wall, a rear wall, two side walls extending between the front and rear walls, and a bottom wall. The device may include other internal walls to create an air flow path from a first one of the side walls to a second one of the side walls. A fan can induce an air flow along the air flow path. Raw plant material can be fed into the device and allowed to fall through the air flow path, and the air flow can separate seeds in the raw plant material from other plant material.

### BACKGROUND

### Technical Field

The present disclosure relates generally to devices for sorting or separating seeds from other materials.

### Description of the Related Art

There is a need in various agricultural industries to separate seeds from other materials. For example, in various industries it may be necessary to separate plant seeds from other plant materials, including leaves, flowers, stalks, stems, etc. As another example, in various industries it may be necessary to sort seeds, once separated from other plant materials, according to their type, grade, weight, density, size, volume, or other properties. These needs have existed for some time, and various systems and techniques have been developed to at least partially address them. Nevertheless, additional developments are still desirable, to improve in the efficiency, effectiveness, performance, and durability of such systems and techniques.

### BRIEF SUMMARY

A device for separating seeds from other plant material may be summarized as comprising: a rear wall; a front wall; a bottom wall; a first side wall that extends from the rear wall to the front wall and from the bottom wall toward a top end of the device; a second side wall that extends from the rear wall to the front wall and from the bottom wall toward a top end of the device; a first drawer positioned within a first bay located adjacent to the first wall and between the bottom wall and a bottom end of the front wall; a second drawer positioned within a second bay located adjacent to the second wall and between the bottom wall and the bottom end of the front wall; a first opening in the first side wall; a second opening in the second side wall; and a fan coupled to the first side wall, the fan configured to induce air flow into the device through the second opening, through the device from the second opening to the first opening, and out of the device through the first opening at a rate of at least 100 cubic feet per minute.

The fan may be configured to induce air flow into the device through the second opening, through the device from the second opening to the first opening, and out of the device through the first opening at a rate of at least 115 cubic feet per minute, at least 200 cubic feet per minute, or at least 400 cubic feet per minute. The fan may be a variable speed fan and may be configured to induce air flow into the device through the second opening, through the device from the second opening to the first opening, and out of the device through the first opening at an adjustable air flow rate that is adjustable across an air flow rate adjustment range. The air flow rate adjustment range may be from 100 cubic feet per minute to 475 cubic feet per minute, from 115 cubic feet per minute to 400 cubic feet per minute, or from 115 cubic feet per minute to 200 cubic feet per minute.

The device may further comprise a power cable electrically coupled to the fan, the power cable being a standardized American power cable. The power cable may have a NEMA-1 plug or a NEMA-5 plug.

The device may further comprise a left side entry wall proximate the top end of the device, a right side entry wall proximate the top end of the device, and an entry gap between a left end of the right side entry wall and a right end of the left side entry wall, the entry gap having a width measured as a largest distance between the left end of the right side entry wall and the right end of the left side entry wall, wherein the width of the entry gap is adjustable across an entry gap width adjustment range. The entry gap width adjustment range may be from 0.5 mm to 5.0 cm, from 1.0 mm to 2.0 cm, or from 2.0 mm to 1.0 cm.

A method of operating a device comprising: a rear wall; a front wall; a bottom wall; a first side wall that extends from the rear wall to the front wall and from the bottom wall toward a top end of the device; a second side wall that extends from the rear wall to the front wall and from the bottom wall toward a top end of the device; a first drawer positioned within a first bay located adjacent to the first wall and between the bottom wall and a bottom end of the front wall; a second drawer positioned within a second bay located adjacent to the second wall and between the bottom wall and the bottom end of the front wall; a first opening in the first side wall; a second opening in the second side wall; and a fan coupled to the first side wall, the fan configured to induce air flow into the device through the second opening, through the device from the second opening to the first opening, and out of the device through the first opening at a rate of at least 100 cubic feet per minute, may comprise: turning on the fan to induce air flow along an air flow path into the device through the second opening, through the device from the second opening to the first opening, and out of the device through the first opening; providing raw plant material including seeds as an initial input to the device; and allowing the raw plant material to fall through the air flow path; wherein the air flow separates the seeds from other plant material, allows the seeds separated from the other plant material to fall into the second drawer, and allows the other plant material to fall into the first drawer.

The method may further comprise: providing the seeds separated from the other plant material as a secondary input to the device; and allowing the seeds separated from the other plant material to fall through the air flow path; wherein the air flow separates the seeds from additional plant material, allows the seeds separated from the additional plant material to fall into the second drawer, and allows the additional plant material to fall into the first drawer. The method may further comprise, prior to providing the raw plant material to the device, adjusting operation of the fan to optimize an air flow speed of the air flow along the air flow path based on characteristics of the seeds. The method may further comprise, after allowing the raw plant material to fall through the air flow path: adjusting operation of the fan to increase or decrease the air flow speed of the air flow along the air flow path; providing additional raw plant material including additional seeds to the device; and allowing the additional raw plant material to fall through the air flow path.

### BRIEF DESCRIPTION OF THE SEVERAL VIEWS OF THE DRAWINGS

FIG. 1 is a perspective view of a seed sorting and separating system according to at least one illustrated implementation.

FIG. 2 is another perspective view of the seed sorting and separating system of FIG. 1 according to at least one illustrated implementation.

FIG. 3 is another perspective view of the seed sorting and separating system of FIG. 1 with a front wall thereof removed, according to at least one illustrated implementation.

FIG. 4 is another perspective view of the seed sorting and separating system of FIG. 1 with the front wall thereof removed, according to at least one illustrated implementation.

FIG. 5 is another perspective view of the seed sorting and separating system of FIG. 1 with the front wall thereof removed, according to at least one illustrated implementation.

FIG. 6 is another perspective view of the seed sorting and separating system of FIG. 1 with the front wall thereof removed, according to at least one illustrated implementation.

FIG. 7 is a front view of the seed sorting and separating system of FIG. 1 with the front wall thereof removed, according to at least one illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with the technology have not been shown or described in detail to avoid unnecessarily obscuring descriptions of the implementations.

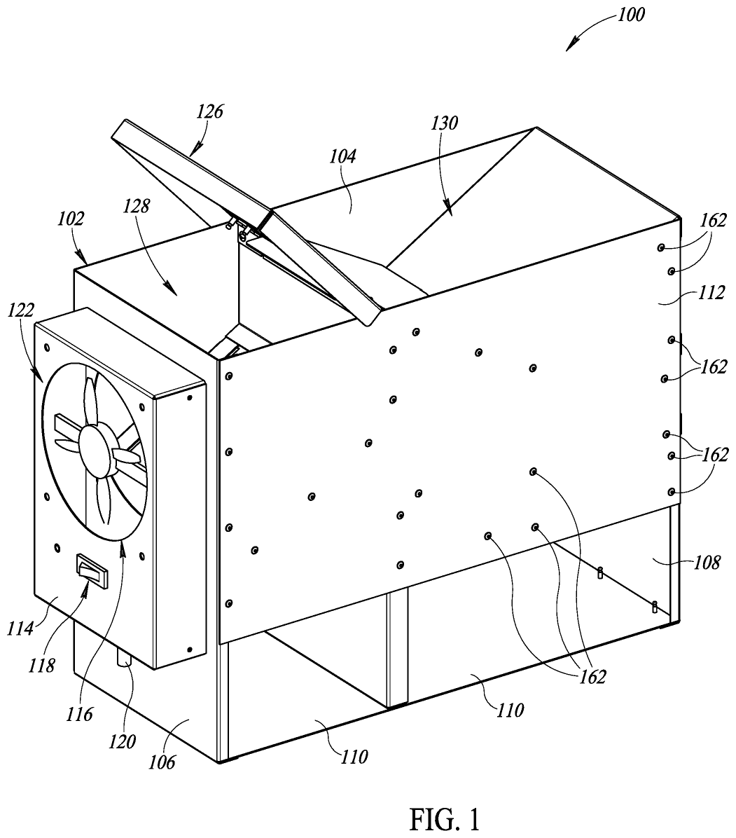

FIG. 1 illustrates a seed sorting and separating system 100. As illustrated in FIG. 1, the seed separating system 100 includes an outer frame or housing including a main body 102 that forms a rear wall 104, a left side wall 106, a right side wall 108, and a bottom wall 110. As illustrated in FIG. 1, the housing also includes a front wall 112 that is coupled to the left and right side walls 106, 108 of the main body 102. As used herein, terms such as “front,” “rear,” “left,” and “right” carry their ordinary meaning with respect to an observer located in front of the system 100 such that the front wall 112 is closer to the observer than the rear wall 104. As used herein, terms of relative elevation, such as “top,” “bottom,” “above,” “below,” etc., carry their ordinary meanings, such that gravity acts to pull items downward, from the top of a system toward the bottom of the system.

As illustrated in FIG. 1, the separating system 100 also includes a case or enclosure 114 coupled to an outer surface of the left side wall 106. The enclosure 114 includes an opening 116 in an outer surface thereof, a switch 118 in the outer surface thereof, and a conduit 120 that extends out of a bottom surface thereof. The enclosure 114 encloses a fan 122 that is positioned within an interior of the enclosure 114 and that is oriented to push, pull, force, urge, or drive air to flow either into or out of the separating system 100 through the opening 116. In some implementations, the fan 122 can be controlled and operated to induce air to flow through the separating system 100 at a rate of at least 100, at least 105, at least 110, at least 115, at least 120, at least 130, at least 140, at least 150, at least 160, at least 170, at least 180, at least 190, at least 200, at least 225, at least 250, at least 275, at least 300, at least 325, at least 350, at least 375, at least 400, at least 425, at least 450, or at least 475 cubic feet per minute, such as by operation of a mechanical rocker switch, roller switch, or dial.

In some implementations, the fan 122 can be a variable speed fan and can be controlled and operated to induce air to flow through the separating system 100 at an adjustable air flow rate. The adjustable air flow rate may be adjustable across an air flow rate adjustment range. In some implementations, the lower end of this range may be 100, 105, 110, 115, 120, 130, 140, 150, 160, 170, 180, 190, 200, 225, 250, 275, 300, 325, 350, 375, 400, 425, or 450 cubic feet per minute. In some implementations, the upper end of this range may be 105, 110, 115, 120, 130, 140, 150, 160, 170, 180, 190, 200, 225, 250, 275, 300, 325, 350, 375, 400, 425, 450, or 475 cubic feet per minute. By adjusting the air flow rate, an operator can optimize the separating performed by the separating system 100, such as based on a type of seed being separated from other plant material, or based on a weight, density, and/or aerodynamics of such a type of seed.

When the separating system 100 is in use or in operation, power and/or communication cables or wires can run into the enclosure 114 through the conduit 120, and can power and/or provide communications including operating instructions to the fan 122. In some implementations, such a power cable or wire can be a standardized American power cable or wire, can be grounded or ungrounded, can have a NEMA-1 plug or connector or a NEMA 5 plug or connector, and can be designed to carry electricity at 120 volts or 240 volts. A user or an operator of the separating system 100 can use or operate the switch 118 to control operation of the fan 122 and the system 100, such as by switching the fan 122 on or off.

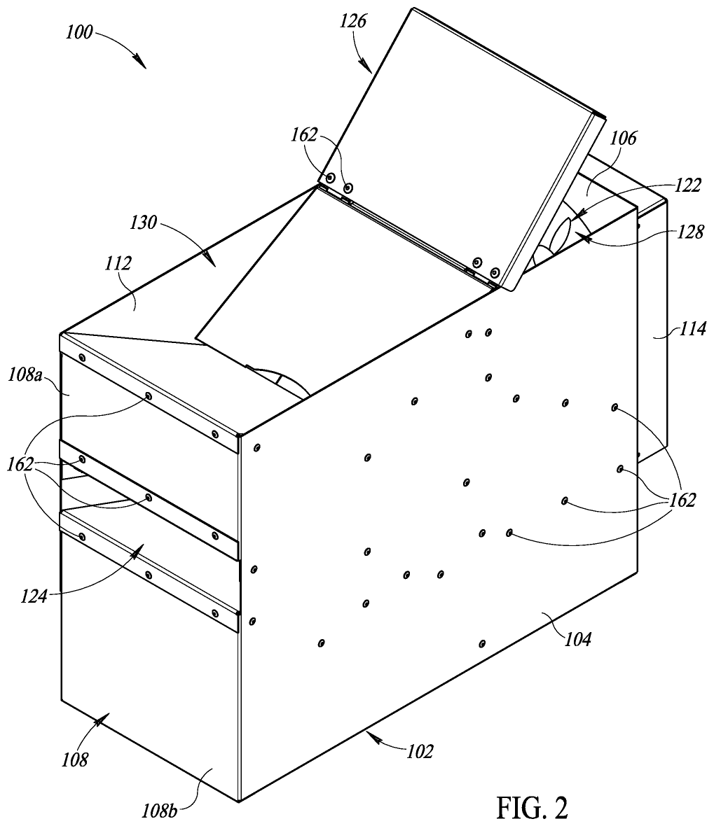

FIG. 2 illustrates a rear perspective view of the separating system 100, including the rear wall 104, left side wall 106, right side wall 108, and front wall 112. As illustrated in FIG. 2, the right side wall 108 includes a top portion 108a thereof, a bottom portion 108b thereof, and an opening 124 therein, which separates the top portion 108a from the bottom portion 108b. When the separating system 100 is in operation, the fan 122 can be switched on to draw air into the system 100 through the opening 124, through the system 100 from the right side wall 108 to the left side wall 106, and out of the system 100 through the opening 116, or in the opposite direction into the system 100 through the opening 116, through the system 100 from the left side wall 106 to the right side wall 108, and out of the system 100 through the opening 124.

As illustrated in FIGS. 1 and 2, the separating system 100 has a top end that includes a left side opening 128 and a right side opening 130. The system 100 also includes a hinged door 126 that can be closed to close the left side opening 128 and opened to allow access to an interior of the system 100 through the left side opening 128. In operation, an operator can open the door 126 to clean out an interior of the system 100 through the opening 128, and then close the door 126 to close the opening 128. The operator can then drop or otherwise position plant materials, including seeds and other plant materials, into the right side opening 130. The plant materials can be carried downward through the separating system 100 under the force of gravity. As the plant materials are carried downward through the system 100, a force, pressure, or other action of the air drawn through the system 100 by the fan 122 can interact with the plant material and other features of the system 100, as described further below, to separate the seeds from the other plant material.

As illustrated in FIG. 1, the front wall 112 spans between the left and right side walls 106, 108, and extends from the top ends of the left and right side walls 106, 108, downward toward the bottom of the system 100, such that a gap is created between a bottom end of the front wall 112 and the bottom wall 110. When the separating system 100 is in operation, one or more drawers or other storage containers can be inserted into the system 100 through the gap between the bottom end of the front wall 112 and the bottom wall 110, such as into one or more bays created within the gap. Such drawers can be pushed into the system from front to back, and such that they span from the front of the system 100 to the rear wall 104 of the system 100 to provide containers with open top ends to receive plant material, such as separated seeds or other plant material, as it falls through the separating system 100.

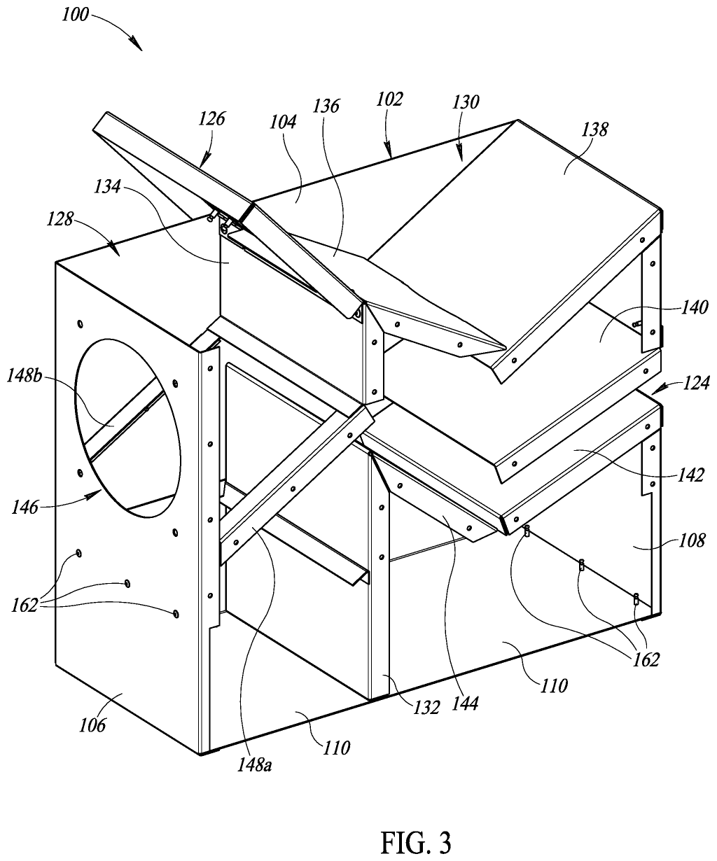

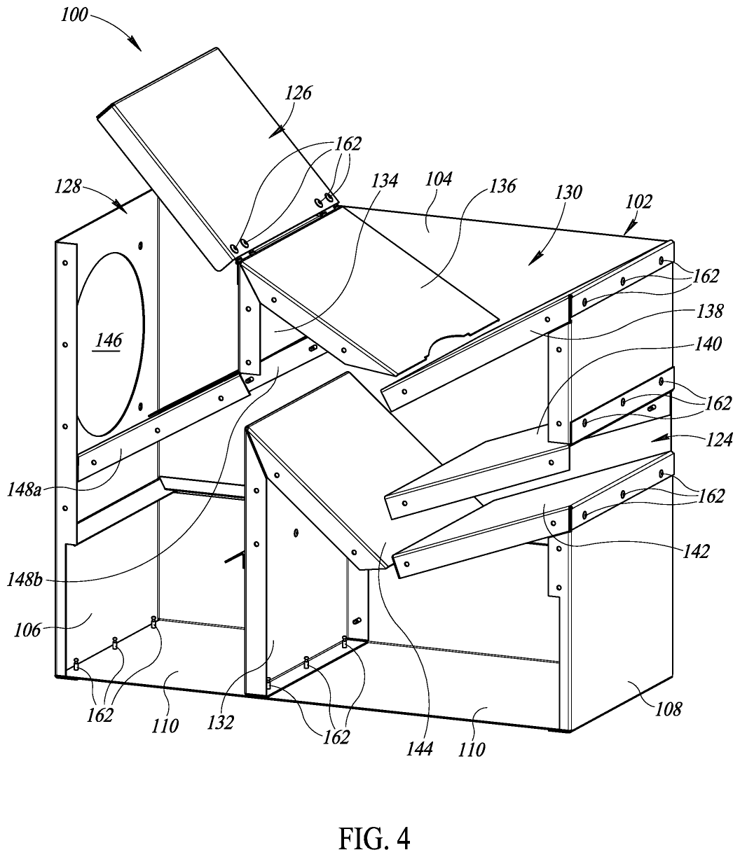

FIGS. 3 and 4 illustrate front, left, and top, and front, right, and top perspective views, respectively, of the separating system 100 with the front wall 112 and the enclosure 114, including its switch 118 and its conduit 120 and the fan 122, as well as the fasteners or rivets holding the front wall 112 to the rest of the system 100, removed to illustrate other internal components of the system 100. As illustrated in FIGS. 3 and 4, the separating system 100 includes a lower central vertical wall 132 and an upper central vertical wall 134 that is positioned directly above the lower central vertical wall 132. The system 100 includes an opening between the two vertical walls 132, 134, wherein the opening separates the lower central vertical wall 132 and the upper vertical wall 134 and allows air to flow side-to-side through the system 100 between the two vertical walls 132, 134.

A bottom portion of the lower central vertical wall 132 divides the gap between a bottom end of the front wall 112 and the bottom wall 110 into two distinct bays for receiving respective distinct drawers for catching falling materials. The two distinct bays can be referred to as a left bay, to the left of the lower central vertical wall 132, and a right bay, to the right of the lower central vertical wall 132. A top portion of the upper central vertical wall 134 divides the top end of the separating system 100 into two distinct openings, the left side opening 128 to the left of the upper central vertical wall 134, and the right side opening 130 to the right of the upper central vertical wall 134.

FIGS. 3 and 4 also illustrate that the separating system 100 includes a left side entry wall 136 and a right side entry wall 138. The left side entry wall 136 extends from a top end of the upper central vertical wall 134 downward and to the right toward the right side entry wall 138. The right side entry wall 138 extends from a top end of the right side wall 108 downward and to the left toward the left side entry wall 136. The right-most and bottom-most end of the left side entry wall 136 is proximate to but separated from the left-most and bottom-most end of the right side entry wall 138 by an entry gap. When the separating system is in operation, the walls 104, 112, 136, and 138 collectively form an entry funnel into which an operator can position mixed plant material. This entry funnel can allow the plant material to fall through the entry gap to direct the flow of the plant material into the interior of the separating system 100.

In some implementations, a width of the entry gap, measured as either a largest or a smallest distance between the right-most and bottom-most end of the left side entry wall 136 and the left-most and bottom-most end of the right side entry wall 138, is adjustable, such as by operation of a mechanical rocker switch, roller switch, or dial. The width of the entry gap may be adjustable across an entry gap width adjustment range. In some implementations, the lower end of this range may be 0.5 mm, 1.0 mm, 1.5 mm, 2.0 mm, 2.5 mm, 3.0 mm, 3.5 mm, 4.0 mm, 4.5 mm, 5.0 mm, 6.0 mm, 7.0 mm, 8.0 mm, 9.0 mm, or 1.0 cm. In some implementations, the upper end of this range may be 5.0 cm, 4.5 cm, 4.0 cm, 3.5 cm, 3.0 cm, 2.5 cm, 2.0 cm, 1.75 cm, 1.5 cm, 1.25 cm, 1.0 cm, 9.0 mm, 8.0 mm, 7.0 mm, 6.0 mm, 5.0 mm, 4.0 mm, 3.0 mm, or 2.0 mm. By adjusting the width of the entry gap, an operator can control the rate at which plant material, including seeds, is allowed to flow through the entry gap into the separating system 100.

FIGS. 3 and 4 also illustrate that the separating system 100 includes an upper air guide wall 140 and a lower air guide wall 142. The upper air guide wall 140 extends from a bottom end of the top portion 108a of the right side wall 108 leftward and downward into the interior of the system 100, and the lower air guide wall 142 extends from a top end of the bottom portion 108b of the right side wall 108 leftward and downward into the interior of the system 100, parallel to and spaced apart from the upper air guide wall 140. A space or a gap created between the two air guide walls 140, 142 guides air either from the opening 124 leftward and downward into the interior of the separating system 100, or from the interior of the separating system 100 rightward and upward toward the opening 124.

FIGS. 3 and 4 also illustrate that the separating system 100 includes a left side exit wall 144 and that the lower air guide wall 142 can form and be referred to as a right side exit wall 142. The left side exit wall 144 extends from a top end of the lower central vertical wall 132 downward and to the right toward the right side exit wall 142. The right side exit wall 142 extends from a top end of the bottom portion 108b of the right side wall 108 downward and to the left toward the left side exit wall 144. The right-most and bottom-most end of the left side exit wall 144 is proximate to but separated from the left-most and bottom-most end of the right side exit wall 142 by an exit gap. When the separating system is in operation, the walls 104, 112, 144, and 142 collectively form an exit funnel into which seeds, having been separating from other plant material, can fall. This exit funnel can allow the seeds to fall through the exit gap to direct the flow of the seeds into a drawer portioned within the right bay to the right of the lower central vertical wall 132.

When the separating system 100 is in operation, the switch 118 can be flipped or actuated to turn on or operate or actuate the fan 122. The fan 122 can draw air into the system 100 through the opening 124 and through the space or channel formed between the walls 140 and 142. The end of this channel can be located vertically between the entry gap between the entry walls 136 and 138 and the exit gap between the exit walls 144 and 142. Thus, the air blowing through the system 100 can interact with the plant material falling into the system through the entry gap to separate seeds from other plant material. Because the seeds are heavier or denser or more aerodynamic than such other plant material, the seeds can fall downward through the air current and through the exit gap into a drawer within the right bay. Because the other plant material is lighter, less dense, or less aerodynamic than the seeds, the other plant material can travel with the air current to the left and through the opening between the two vertical walls 132 and 134. In other implementations, the system 100 can work on a similar principle to separate different types of seeds having different weights, densities, etc. from one another.

FIGS. 3 and 4 also illustrate that the left side wall 106 includes a circular opening 146 therein, which can be open to an interior of the enclosure 114 when the enclosure 114 is coupled to the left side wall 106. The opening 146 can be longitudinally aligned with and have the same or a similar diameter as the opening 116, such that the fan 122 can efficiently propel air into the system 100 through the opening 116 and then through the opening 146, or out of the system 100 through the opening 146 and then through the opening 116. FIGS. 3 and 4 also illustrate that the separating system 100 includes a peripheral frame 148 that includes a front portion 148a and a rear portion 148b. The peripheral frame 148 can be a wall similar to the other walls described herein but with a large opening at its center, such that the peripheral frame 148 extends only along peripheral edges of an area a comparable solid wall would occupy.

FIGS. 3 and 4 also illustrate that the peripheral frame 148 extends from a bottom end of the upper central vertical wall 134 downward and leftward to approximately a midpoint of the left side wall 106, below the opening 146. When the separating system 100 is in operation, a filter, mesh, or screen can be mounted to the peripheral frame 148. Thus, when the separating system 100 is in operation, the fan 122 can draw air through the system 100 as described above, through the opening between the two vertical walls 132 and 134, through the opening at the center of the peripheral frame 148 and through any screen mounted thereon, through the opening 146, through the fan 122 itself, and out of the system 100 through the opening 116. As the air travels along this flow path, the other plant material, having been separated from the seeds and carried by the air flow through the opening between the two vertical walls 132 and 134, encounters the screen mounted to the peripheral frame 148 and is separated from the air flow. When sufficient plant material builds up on the underside of the screen in this manner, the plant material can fall under its own weight from the screen into a drawer positioned within the left bay to the left of the lower central vertical wall 132.

FIGS. 3 and 4 also illustrate that the hinged door 126 is rotatably coupled by a hinge to a top end of the upper central vertical wall 134 and extends from the hinged connection leftward and, in a closed configuration, horizontally and leftward to a top end of the left side wall 106 and, in an open configuration, upward and leftward to create the left side opening 128 at the top end of the system 100. Thus, the hinged door 126 can rotate clockwise as viewed from the front to be opened and can rotate counter clockwise as viewed from the front to be closed. Each of the walls described herein, as well as the door 126, extends strait across the interior of the system 100 from front-to-back or back-to-front, and all of the walls and the door 126 have a common major axis that is oriented front-to-back with respect to the system 100.

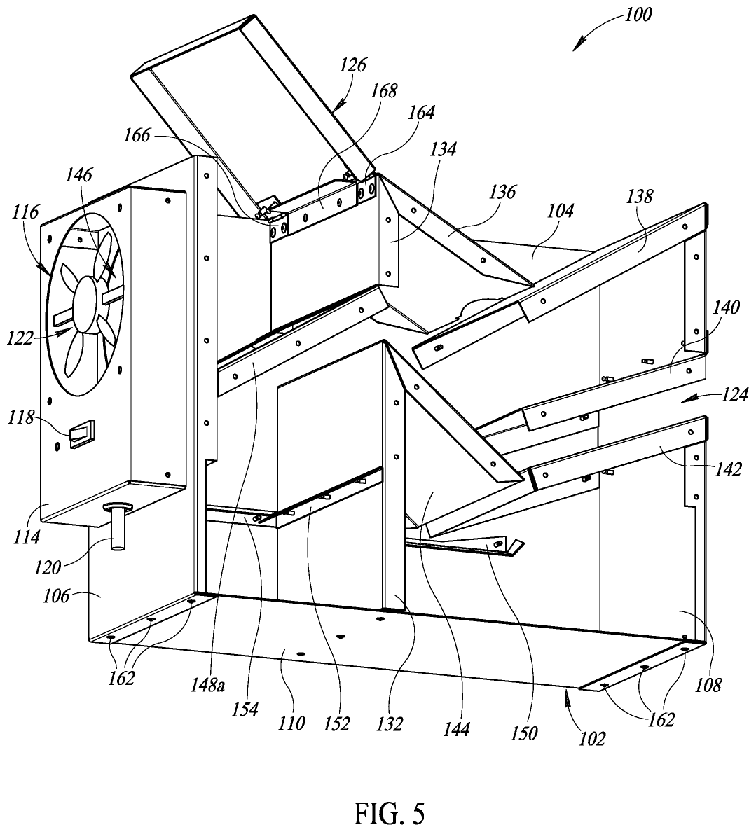

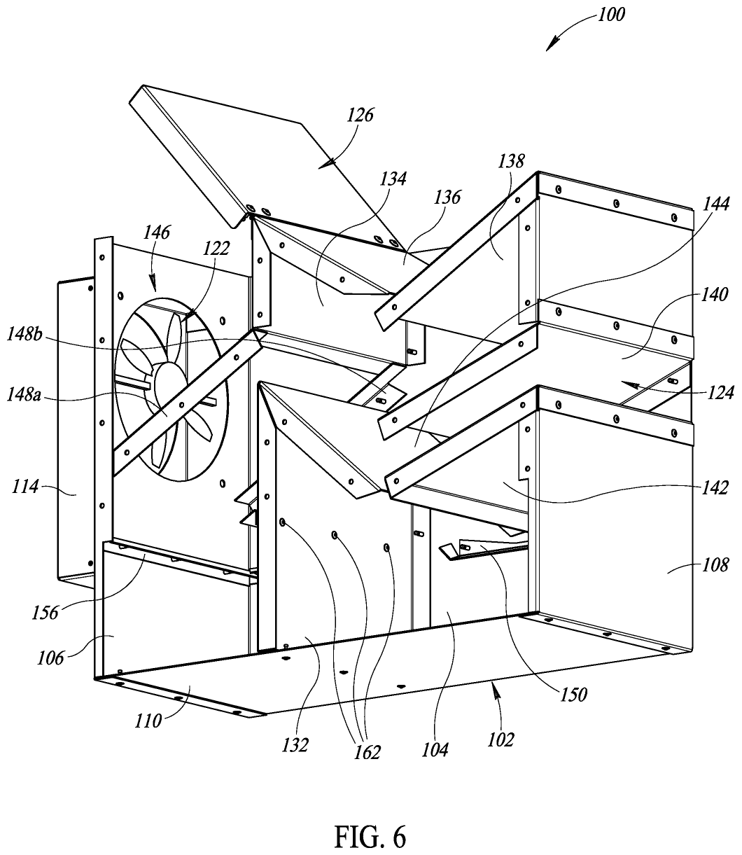

FIGS. 5 and 6 illustrate front, left, and bottom, and front, right, and bottom perspective views, respectively, of the separating system 100 with the front wall 112, as well as the fasteners or rivets holding the front wall 112 to the rest of the system 100, removed to illustrate other internal components of the system 100. As illustrated in FIGS. 5 and 6, the door 126 is coupled to the upper central vertical wall 134 by a first hinge 164 positioned at a front of the system 100 and by a second hinge 166 positioned at a rear of the system 100. As also illustrated in FIGS. 5 and 6, the system 100 includes a support shaft 168 coupled to the upper central vertical wall 134 that extends leftward away from the upper central vertical wall 134 and supports an underside of the door 126 when the door 126 is closed.

As also illustrated in FIGS. 5 and 6, the separating system 100 includes a first guide 150 coupled to the rear wall 104 at a location just below the exit gap between the exit walls 144 and 142 and just above the gap between the bottom end of the front wall 112 and the bottom wall 110. The first guide 150 provides a ramp that guides seeds falling through the exit gap away from the rear wall 104, to ensure the seeds fall into a drawer positioned in the right bay. As also illustrated in FIGS. 5 and 6, the separating system 100 includes second, third, and fourth guides 152, 154, and 156 coupled to the lower central vertical wall 132, the rear wall 104, and the left side wall 106, respectively, at respective locations below the frame 148, below the opening between the two vertical walls 132, 134, and just above the gap between the bottom end of the front wall 112 and the bottom wall 110. The second, third, and fourth guides 152, 154, and 156 provide ramps that guide plant material falling through the system 100 away from the lower central vertical wall 132, the rear wall 104, and the left side wall 106, respectively, to ensure the plant material falls into a drawer positioned in the left bay.

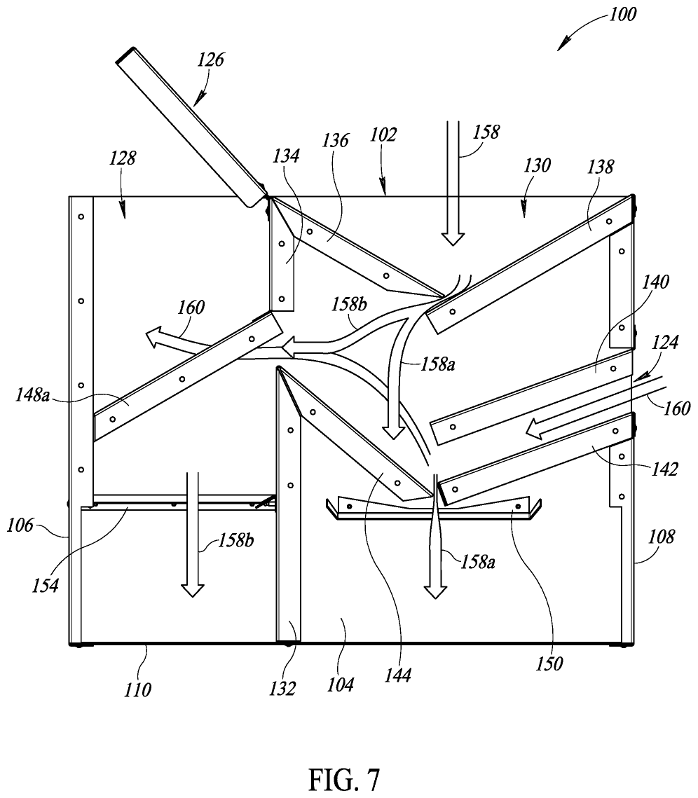

FIG. 7 illustrates a front view of the separating system 100 with the front wall 112 and the enclosure 114, including its switch 118 and its conduit 120 and the fan 122, as well as the fasteners or rivets holding the front wall 112 to the rest of the system 100, removed to illustrate other internal components of the system 100. As illustrated in FIG. 7, the separating system 100 includes an air flow path 160 by which air flows into and through the system 100. The separating system 100 also includes a plant material flow path 158, which splits into a seed flow path 158a and an other plant material flow path 158b when the flow path 158 meets or intersects with the air flow path 160. The seeds and other plant material travel into and through the system 100 along the plant material flow path 158, the seed flow path 158a, and the other plant material flow path 158b.

When operation of the separating system 100 has ended, an operator can turn off the fan 122 by flipping the switch 118 to stop the flow of air through the system 100. The operator can also withdraw the drawers from their respective bays at the bottom of the system 100 to remove the seeds and other plant material from the system 100. The operator can also open the door 126 to clean out an internal space between a screen mounted on the peripheral frame 148 and the fan 122 and/or to replace the screen if needed.

In some implementations, an operator can use the separating system 100 to perform multiple separation passes on an initial batch of plant material. For example, the operator can provide initial or raw plant material including seeds as the initial input plant material to the separating system 100 and operate the separating system 100 as described herein to separate the seeds from other plant material in a first pass. The operator can then provide the seeds separated from the other plant material in the first pass as a secondary input plant material to the separating system 100 and operate the separating system 100 as described herein to separate the seeds from additional plant material in a second pass. Any suitable number of passes, such as 1, 2, 3, 4, 5, 6, 7, 8, 9, or 10 passes, can be performed until the seeds have been adequately or desirably separated from other plant material.

In some implementations, an operator can use the separating system 100 to separate multiple, different types of seeds from other plant material. For example, the operator can adjust the operation of the fan 122 and the gap width to optimize performance of the separating system 100 for separating seeds of a first type. The operator can then provide initial or raw plant material including seeds of the first type as the initial input plant material to the separating system 100 and operate the separating system 100 as described herein to separate the seeds from other plant material. The operator can then adjust the operation of the fan 122 and the gap width to optimize performance of the separating system 100 for separating seeds of a second type different than the first type. This can include increasing or decreasing the air flow rate and/or increasing or decreasing the gap width. The operator can then provide initial or raw plant material including seeds of the second type as the initial input plant material to the separating system 100 and operate the separating system 100 as described herein to separate the seeds from other plant material. Any suitable number of different types of seeds, such as 1, 2, 3, 4, 5, 6, 7, 8, 9, or 10 different types of seeds, can be separated from other plant material using the separating system 100 in this manner.

It has been found that existing seed sorting systems suffer from premature deterioration and degradation due at least in part to wear resulting from the flow of air and plant material through the systems over extended periods of time. Nevertheless, it can be difficult to know in advance which components of the systems, if any, warrant the additional cost associated with improvements in quality. It has been found that, in general, improvements to the quality of the connections between the various parts of seed sorting and separating systems often warrant the additional cost associated therewith.

Thus, in the seed sorting and separating system 100, various components thereof are coupled to one another using rivets 162. Except where otherwise stated, various connections described herein are made by positioning a first surface of a first component flush against a second surface of a second component, and the first and second components are coupled to one another by multiple rivets. Further, except where otherwise stated, in connections made using two rivets, the two rivets are positioned proximate respective opposite ends of the flush surfaces. Further, except as otherwise stated, in connections made using three rivets, the three rivets are positioned proximate respective opposite ends and proximate a center of the flush surfaces.

In the system 100, the lower central vertical wall 132 is coupled to the front wall 112 by two rivets each located proximate a top end of the lower central vertical wall 132. The upper central vertical wall 134 is coupled to the front wall 112 by two rivets. The left side entry wall 136 is coupled to the front wall 112 by two rivets. The right side entry wall 138 is coupled to the front wall 112 by two rivets. The upper air guide wall 140 is coupled to the front wall 112 by two rivets. The lower air guide wall 142 is coupled to the front wall 112 by two rivets. The left side exit wall 144 is coupled to the front wall 112 by two rivets. The front portion 148a of the peripheral frame 148 is coupled to the front wall 112 by three rivets. The left side wall 106 is coupled to the front wall 112 by four rivets, each spaced apart from the next by the same distance, and collectively located closer to the top of the left side wall 106 than to the bottom of the left side wall 106. The top portion 108a of the right side wall 108 is coupled to the front wall 112 by two rivets. The bottom portion 108b of the right side wall 108 is coupled to the front wall 112 by two rivets, collectively located closer to the top of the bottom portion 108b of the right side wall 108 than to the bottom of the bottom portion 108b of the right side wall 108.

The lower central vertical wall 132 is coupled to the rear wall 104 by two rivets collectively located closer to a bottom end of the lower central vertical wall 132 than to a top end of the lower central vertical wall 132. The upper central vertical wall 134 is coupled to the rear wall 104 by two rivets. The left side entry wall 136 is coupled to the rear wall 104 by two rivets. The right side entry wall 138 is coupled to the rear wall 104 by two rivets. The upper air guide wall 140 is coupled to the rear wall 104 by two rivets. The lower air guide wall 142 is coupled to the rear wall 104 by two rivets. The left side exit wall 144 is coupled to the rear wall 104 by two rivets. The rear portion 148b of the peripheral frame 148 is coupled to the rear wall 104 by three rivets. The first guide 150 is coupled to the rear wall 104 by two rivets. The third guide 154 is coupled to the rear wall 104 by three rivets.

The left side wall 106 is coupled to the bottom wall 110 by three rivets. The right side wall 106 is coupled to the bottom wall 110 by three rivets. The lower central vertical wall 132 is coupled to the bottom wall 110 by three rivets. The upper central vertical wall 134 is coupled to the first hinge 164 by two rivets. The upper central vertical wall 134 is coupled to the second hinge 164 by two rivets. The upper central vertical wall 134 is coupled to the support shaft 168 by two rivets. The hinged door 126 is coupled to the first hinge 164 by two rivets. The hinged door 126 is coupled to the second hinge 164 by two rivets. The right side entry wall 138 is coupled to the top portion 108a of the right side wall 108 by three rivets. The upper air guide wall 140 is coupled to the top portion 108a of the right side wall 108 by three rivets. The lower air guide wall 142 is coupled to the bottom portion 108b of the right side wall 108 by three rivets. The second guide 152 is coupled to the lower central vertical wall 132 by three rivets. The fourth guide 156 is coupled to the left side wall 106 by three rivets.

Aspects and features of the various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A device for separating seeds from other plant material, comprising:
a rear wall;
a front wall;
a bottom wall;
a first side wall that extends from the rear wall to the front wall and from the bottom wall toward a top end of the device;
a second side wall that extends from the rear wall to the front wall and from the bottom wall toward a top end of the device;
a first drawer positioned within a first bay located adjacent to the first wall and between the bottom wall and a bottom end of the front wall;
a second drawer positioned within a second bay located adjacent to the second wall and between the bottom wall and the bottom end of the front wall;
a first opening in the first side wall;
a second opening in the second side wall; and
a fan coupled to the first side wall, the fan configured to induce air flow into the device through the second opening, through the device from the second opening to the first opening, and out of the device through the first opening at a rate of at least 100 cubic feet per minute.

2. The device of claim 1 wherein the fan is configured to induce air flow into the device through the second opening, through the device from the second opening to the first opening, and out of the device through the first opening at a rate of at least 115 cubic feet per minute.

3. The device of claim 1 wherein the fan is configured to induce air flow into the device through the second opening, through the device from the second opening to the first opening, and out of the device through the first opening at a rate of at least 200 cubic feet per minute.

4. The device of claim 1 wherein the fan is configured to induce air flow into the device through the second opening, through the device from the second opening to the first opening, and out of the device through the first opening at a rate of at least 400 cubic feet per minute.

5. The device of claim 1 wherein the fan is a variable speed fan and is configured to induce air flow into the device through the second opening, through the device from the second opening to the first opening, and out of the device through the first opening at an adjustable air flow rate that is adjustable across an air flow rate adjustment range.

6. The device of claim 5 wherein the air flow rate adjustment range is from 100 cubic feet per minute to 475 cubic feet per minute.

7. The device of claim 5 wherein the air flow rate adjustment range is from 115 cubic feet per minute to 400 cubic feet per minute.

8. The device of claim 5 wherein the air flow rate adjustment range is from 115 cubic feet per minute to 200 cubic feet per minute.

9. The device of claim 1, further comprising a power cable electrically coupled to the fan, the power cable being a standardized American power cable.

10. The device of claim 9 wherein the power cable has a NEMA-1 plug.

11. The device of claim 9 wherein the power cable has a NEMA-5 plug.

12. The device of claim 1, further comprising:
a left side entry wall proximate the top end of the device, a right side entry wall proximate the top end of the device, and an entry gap between a left end of the right side entry wall and a right end of the left side entry wall, the entry gap having a width measured as a largest distance between the left end of the right side entry wall and the right end of the left side entry wall, wherein the width of the entry gap is adjustable across an entry gap width adjustment range.

13. The device of claim 12 wherein the entry gap width adjustment range is from 0.5 mm to 5.0 cm.

14. The device of claim 12 wherein the entry gap width adjustment range is from 1.0 mm to 2.0 cm.

15. The device of claim 12 wherein the entry gap width adjustment range is from 2.0 mm to 1.0 cm.

16. A method of operating a device comprising:
a rear wall;
a front wall;
a bottom wall;
a first side wall that extends from the rear wall to the front wall and from the bottom wall toward a top end of the device;
a second side wall that extends from the rear wall to the front wall and from the bottom wall toward a top end of the device;
a first drawer positioned within a first bay located adjacent to the first wall and between the bottom wall and a bottom end of the front wall;
a second drawer positioned within a second bay located adjacent to the second wall and between the bottom wall and the bottom end of the front wall;
a first opening in the first side wall;
a second opening in the second side wall; and
a fan coupled to the first side wall, the fan configured to induce air flow into the device through the second opening, through the device from the second opening to the first opening, and out of the device through the first opening at a rate of at least 100 cubic feet per minute,
the method comprising:
turning on the fan to induce air flow along an air flow path into the device through the second opening, through the device from the second opening to the first opening, and out of the device through the first opening;
providing raw plant material including seeds as an initial input to the device; and
allowing the raw plant material to fall through the air flow path;
wherein the air flow separates the seeds from other plant material, allows the seeds separated from the other plant material to fall into the second drawer, and allows the other plant material to fall into the first drawer.

17. The method of claim 16, further comprising:
providing the seeds separated from the other plant material as a secondary input to the device; and
allowing the seeds separated from the other plant material to fall through the air flow path;
wherein the air flow separates the seeds from additional plant material, allows the seeds separated from the additional plant material to fall into the second drawer, and allows the additional plant material to fall into the first drawer.

18. The method of claim 16, further comprising, prior to providing the raw plant material to the device, adjusting operation of the fan to optimize an air flow speed of the air flow along the air flow path based on characteristics of the seeds.

19. The method of claim 18, further comprising, after allowing the raw plant material to fall through the air flow path:
adjusting operation of the fan to increase or decrease the air flow speed of the air flow along the air flow path;
providing additional raw plant material including additional seeds to the device; and
allowing the additional raw plant material to fall through the air flow path.
